(19) United States
(12) Patent Application Publication
(10) Pub. No.: US 2010/0131502 A1
(43) Pub. Date: May 27, 2010

(54) COHORT GROUP GENERATION AND AUTOMATIC UPDATING

(76) Inventor: Bradley S. Fordham, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/323,447

(22) Filed: Nov. 25, 2008

(51) Int. Cl. G06F 7/06; G06F 17/30; G06F 15/16

(52) U.S. Cl. 707/736; 709/207; 707/E17.014; 707/E17.044

(57) ABSTRACT

Techniques for creating and utilizing cohort groups help to facilitate connectedness. Cohort groups can be created, built and utilized to identify parties that could and/or should be connected. The cohort groups can be easily and quickly created and modified both passively and actively, through automated and semi-automated means. Users provide profile information to the system. The system can generate cohort groups based on the provided information, as well as updated information, relationship rules between the information, geographic locations of the users, semantic processing, advanced inferences (such as artificial intelligence or other techniques), and self-identified affiliations.

### BACKGROUND

The present invention is directed towards identifying associations between entities and, more specifically, various techniques to identifying entities, identifying associations between these entities, affiliating the entities with groupings such that the groupings can be used to aid in other activities, such as communication enhancements.

Have you ever found yourself striking up a conversation with a perfect stranger sitting next to you on an airplane, only to discover that you have something remarkable in common with each other? For instance, the person may be neighbors with your best friend, or you may have both attended the same university at the same time, or the person may have gone to high school with your spouse, or they have a child on your child's baseball team, etc. These situations always seem to reach that pivotal moment when one of the parties says, “It's a small world isn't it?”

These moments are typically met with great wonder and in many cases, are quite welcomed events. However, should the occurrence of such seemingly random events surprise you? There is a book having the title of Coincidences, Chaos, and All That Math Jazz: Making Light of Weighty Ideas written by Edward B. Burger and Michael Starbird that specifically addresses this subject. The book sets forth the proposition that looking at the mathematical statistics, you should actually expect such seemingly random events to occur in your life. In fact, the book says you should be surprised if you don't experience such events.

But what if you could do something that would increase the likelihood of such experiences? For instance, rather than just haphazardly talking to the person sitting next to you on the airplane, suppose you could intelligently and selectively strike up a conversation with anyone around you on the plane, in a waiting room, on a bus, at your child's baseball game, at a party, at a wedding, etc. What would happen if you could eliminate the elements of risk and chance in bumping into someone with whom you share something in common and could guarantee that every time you introduced yourself to someone new some level of commonality would be there and would be known to you?

A cohort group is a band of people, typically having a shared link based on one or more of a variety of factors. These factors can include demographics and/or statistics such as age, interests, affiliations, background, activities, associations, heritage, inclinations, etc. As such, cohort groups are groups of people who share one or more commonalities—along any of an infinite number of dimensions. The seemingly random happenstances previously described are simply discoveries of persons within one or more of your cohort groups in an ad-hoc way that many people avoid altogether out of a sense of risk—a risk for rejection, avoidance, misinterpretation, etc.

Even in today's connected wired and wireless world, it is difficult to identify cohort groups. This is particularly difficult to do dynamically or “on the fly” as we walk around and live our daily lives. The inability to identify cohort groups is problematic in that it limits our capacity to fulfill some basic human needs or desires, such as (a) expanding our personal networks; (b) sharing information, learning, and collaborating with others; and (c) deepening our interactions with others—especially those critical “first-contact” relationships which are easily missed simply because we had no way to know, immediately, what we held in common with a new acquaintance. Finding a solution to identifying cohort groups has proven to be quite problematic.

The size of this problem is better realized when one considers and understands just how many cohort groups a single person is typically a member of and just how many missed interpersonal opportunities occur each day because those commonalities go unnoticed.

A few non-limiting examples of categorizations for cohort groups include:
Occupation: those people who work at similar jobs
Education: those people who have achieved the same level of education or attended the same schools
Regional Affinity: those people who were born or lived a significant amount of time in the same towns or cities
Political Beliefs: those people who work for the same candidates or are members of the same political organizations
Hobbies: those people who enjoy spending their off hours engaged in similar activities
Organizations: those people who belong to the same club, charitable organization, service organization, etcetera
Achievements: those people that have earned the same or similar military rank, business/professional commendations, etcetera

There are many advantages to being able to identify cohort groups and determine or identify people that belong to one of your cohort groups. The failure in identifying such information, on the other hand, can be a significant disadvantage. A few non-limiting examples include:
Walking into an interview and not knowing whether or not you have anything in common with the interviewer can certainly cost one the job
Sitting in a waiting room with other people—mostly strangers—and not being able to strike up a relevant conversation can certainly make the waiting experience less enjoyable and productive
Attending a conference or meeting and not being able to pick out the most relevant contacts can limit a business' revenue and profits
Going to a concert, sporting event, or other event and not knowing anything about the people sitting right around you can not only limit your enjoyment of the event but also inhibit our natural, human desires to meet new people with something in common.

In essence, the failure to identify cohort groups and exploit them can greatly limit socialization and integration across an entire society, nation, and ultimately humanity as a whole. Thus, there is a need in the art and it would be advantageous to have a solution that can help identify cohort groups, identify cohort groups on the fly, and also to assist members in benefitting from and utilizing this information.

A competing human interest with this need in the art is the desire and a need for privacy. An individual's privacy is an important ingredient that must be considered in identifying and utilizing cohort groups. For instance, there are places and times where cohort group identification is not desired and there may be cohort groups that a given person for a particular interval of time (sometimes forever) does not want to advertise his or her membership in or seek out others around. Thus, it is important that any solution should recognize the full scope of the problem. There is a need in the art for a technique to identify and utilize cohort groups, but still maintain the ability for individuals to maintain complete or selective privacy.

Although some techniques have been developed to meet these needs in the art, they generally fall short of optimum solutions. For instance, common membership in cohort groups certainly can be identified through conversations. A person could be introduced to another by a third party who was aware of their common affiliation and would present it during the introduction. Also, one may manually browse through directories, forums, user groups, etcetera to find other people who belonged to a given cohort group. In each of these approaches, there is a high burden of effort on the cohort seeker and a low degree of automation, sophistication, and immediacy in the cohort discovery. Additionally there is far less real-time control of cohort affiliation and identity management available to all parties. Thus, there is a need in the art for a solution to identify and utilize cohort groups in a manner that provides a level of real-time automation and software decision support.

### BRIEF SUMMARY

Various embodiments, as well as aspects and features that can be incorporated into various embodiments of the invention are now summarized. It should be appreciated that this summary section only identifies some embodiments, aspects and features and the absence of other embodiments, aspects and features from this summary section does not limit the full scope of the invention in any manner.

The various embodiments of the present invention are directed towards meeting the above-described needs in the art, as well as other needs by providing a solution that addresses one or more functional elements. One such functional element is providing individuals with the ability to self-identify with cohort groups and manage their identification with these groups over time by having access to functionality including the ability of adding, dropping and/or changing the identifications. Another functional element includes the ability for individuals to toggle, such as between an on and off state, the broadcast and/or advertisement of their identification with each cohort group. Further, this element can be provided or met in a wide variety of ways including, but not limited to, providing the ability to toggle based on time of day, day of the week, holiday, present location, manually controlled, proximity to other persons, events, activity (i.e., moving in traffic), etc.

Yet another functional element includes providing individuals with the ability to control the actual receipt/transmission of alerts from/to fellow cohort-group members. This functional element can include a variety of capabilities. For instance, the communication channels utilized and the types of alerts broadcast may be individually controllable. As an example, alerts may be broadcast in real-time to people that are in your surrounding area by means of Bluetooth technology transmissions, or alerts may be sent in near real-time to a screen at an event via a rich HTML (web formatted) presentation service or a short messaging service (SMS) or other texting service, or alerts may be sent in batch to a dynamically formed email list for a cohort group in your area. Furthermore, the timing of when alerts are made or sent can be controlled. For instance, a party may choose to disable alerts from being sent and/or received after a certain time (e.g., midnight) local time or, completely block the reception or transmissions on certain days (e.g. weekends or weekdays). Another control may include the ability to limit or augment the content that is included in transmitted alerts to others regarding a party's cohort group affiliation. For instance, the alert may include any of a variety of information such as the party's photograph, profile text, location, other affiliations, contact information, status, custom text, etc. In addition, rules can be used to define, control or constrain the transmission or reception of alert notifications. For example, a rule can be established to transmit an alert to an identified person only if they share two or more cohort groups with the sending or related party and/or they are in a particular age range. Similarly, rules can be based on specific parties that are identified as allowed or blocked, age groups, status, profile specifics etc. It will be appreciated that a large number of rules could be used in conjunction with this functionality and the example provided is for illustrative purposes only.

Another functional element includes providing individuals with the ability to scope or probe the cohort alert notification or the system generating the alert to gain additional information. This element may include the ability for a party to configure parameters for the scope or probe, including any combination of automatic or manually initiated triggering events. Thus, the scoping can include a wide range of configuration options, including but not limited to:
(a) notification based on proximity—the scoping can enable the parties to define a distance or range and enable notifications when a new cohort enters that range;
(b) notification when a new cohort self-identifies—the scoping can enable a party to establish allowing or filtering criteria that limit these new cohort alerts—e.g. only allowed for those of a specified sex, age range, home state, etc.
(c) notification when a known cohort presents an unknown cohort to you—the scoping can enable “dynamically linking” cohort groups so that whenever this known cohort identifies a new cohort in one or more cohort groups linked to yours, an alert is automatically triggered back to you.
(d) notification by query or search—the scoping can enable a participant to enter a name, a city, or some other criteria and then be notified of cohorts in each cohort group that satisfy this criteria set.

Another functional element includes the ability to have the alerts delivered or received over a wide variety of channels. A few non-limiting examples of channels include printed correspondence carried by a postal service, Bluetooth connections, email, SMTP, IMAP, intranets, Internet, SMS, text messaging, telephone, etc. Additionally, this functional element may include the ability for alerts to automatically select which channel(s) for the initial transmission and any necessary re-transmissions including failing over from one channel to another.

One embodiment of the present invention operates to dynamically generate and update cohort groups, also referred to generally as associations, based on characteristics and providing alert messages to one or more entities affiliated with an association. In the context of the various embodiments, the term association is used generally to refer to any grouping that can be based on any of a variety of criteria. Thus, any criteria selected by the system to relate parties can be used to create a cohort group or an association. In this embodiment of the invention, pertinent information is received from various entities and stored into a profile database. The embodiment operates to examine the pertinent data in the profile database to identify one or more characteristics that exist in the pertinent information of two or more entities to form cohort associations. This characteristic could be a common piece of information or a trait, or information or traits related by some additional rule(s) or more indirect relationships. As an example, the trait of looking for a product could be related by a rule to a trait of having the product. Based at least in part on the identified characteristics and rules, associations can be created. The entities that then share the characteristics are then affiliated with the association. This affiliation may include sending an alert to the entity and receiving a confirmation.

Furthermore, an embodiment of the invention may also operate to detect an event, determine if the event has an effect on the affiliation of two or more entities with an association, and if so, sending an alert message to each entity affected by the event. For example, the detected event may include a person's age changing and, if at least two affiliated entities are within an age threshold relationship to each other, the alert message may convey this information. Similarly, the detected event may include receiving location information for one or more entities and determining that at least two entities are within a threshold geographic range. Upon such detection, the embodiment may send an alert message indicating that the two or more entities are affiliated with an association based at least in part upon their respective locations.

### BRIEF DESCRIPTION OF THE SEVERAL VIEWS OF THE DRAWING

FIG. 1 is a system block diagram showing functional components that may be included in various embodiments of the present invention and that represents a generic environment suitable for embodiments of the present invention.

FIG. 2 is a communication flow diagram illustrating the operation of various components and communication flow in an exemplary embodiment of the present invention.

FIG. 3 is communication flow diagram illustrating additional operations of various components and communication flow in an exemplary embodiment of the present invention.

### DETAILED DESCRIPTION OF EMBODIMENTS OF THE INVENTION

The present invention, as well as features and aspects thereof, is directed towards the generation of cohort groups, and the utilization of cohort groups in the facilitation of connectedness between parties. From the following description, it will be seen that various embodiments of the present invention provide unique and novel mechanisms for identifying and building cohort groups and using cohort groups to identify parties that can and should be connected. Some embodiments of the present invention are particularly well suited to exploit mobile technology in creating connections between parties based on cohort groups.

The various embodiments of the invention provide the functionality for individuals (or even in some instances, systems or processes—generally all referred to as entities) to quickly and easily configure the cohort groups or associations that one chooses to affiliate with and then find, both passively and actively, through automated and semi-automated means, previously unknown people who also self-identify or are affiliated with one or more of his/her cohort groups.

Now turning to the figures, various embodiments, as well as features and aspects of these embodiments are described in more detail.

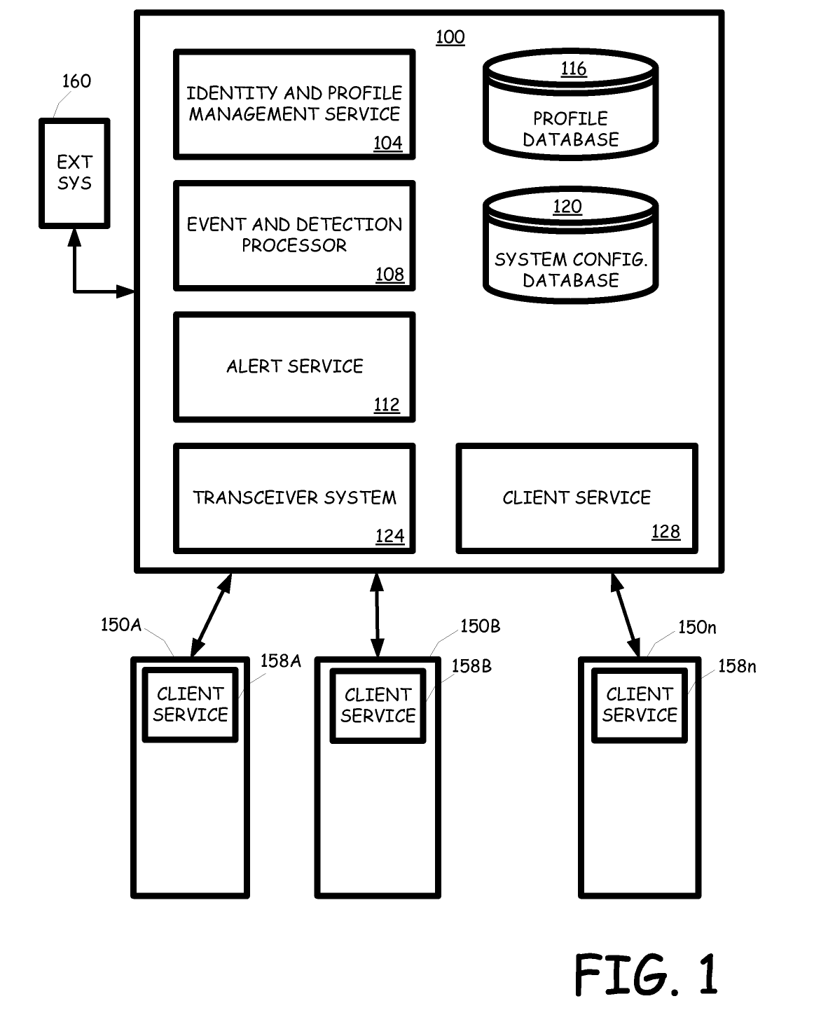

FIG. 1 is a system block diagram showing functional components that may be included in various embodiments of the present invention and that represent a generic environment suitable for embodiments of the present invention. The illustrated environment includes a service platform 100, one or more client devices 150A-150n and potentially an external system 160. It will be appreciated that although in this exemplary embodiment of the invention the service platform 100 is viewed as a server or group of servers interacting with mobile devices or remote devices, the present invention can also be embodied in a variety of other settings, including but not limited to, a completely distributed system in which remote devices simply interact and interface with each other, a partially distributed system, or the like.

The service platform 100 is shown as including multiple functional components. These functional components are separated out as shown to illustrate functional operations of the various embodiments and are not intended to limit the invention to having any particular structure or division of components. The illustrated embodiment includes an identify and profile management service 104, an event and detection processor 108, and alert service module 112, a profile database 116, a system configuration database 120, a transceiver system 124 and a client service 128.

The identity and profile management service 104 provides functionality to enable users to create a profile or an identity for themselves. This includes the users, or entities providing information that is pertinent to the entity. Part of the information provided for the profile or identity may include cohort groups with which entities identify or with which they wish to be affiliated. These cohort groups can be attached to the profile and in some embodiments may be searched by others.

Various embodiments may solicit, accept or allow different types and amounts of information in creating a profile. Some embodiments may require minimal information, some embodiments may require minimal information and allow optional information to be provided, some embodiments may allow parties to define new information, some embodiments may allow external parties or entities to provide further information for a profile, some embodiments may seek further information from external sources, some embodiments may generate or intelligently identify and include additional information, some embodiments may filter or limit certain information, etc. For instance, in one embodiment, the profile information stored and managed as a part of a cohort's identity by the identify and profile management service 104 may include the following information:
(a) the name of the user or entity, or some other unique identifier selected or assigned by or to the party;
(b) a list (which may potentially or initially be empty) of cohort groups or associations with which the party self-identifies;
(c) a list (which may potentially or initially be empty) of contact mechanisms and external identities for the entity, such as email addresses, IM identities, telephone/pager numbers, FACEBOOK identities, LINKEDIN identities, MYSPACE identities, etc, that can be used to contact this party and send cohort alerts (note that if this list is empty the only way, or a default way in which the cohort can receive cohort alerts is through being “logged in” to the service platform 100 or the identity and profile management service 104 and accessing those alerts directly);
(d) a list (which may potentially or initially be empty) of known cohorts within each cohort group;
(e) a list (which may potentially or initially be empty) of cohort alerts that are pending;

Further, the above-described embodiment may also allow additional profile information to be loaded, generated and/or managed by the identity and profile management service 104. Such additional information may include, but is not required or limited to:
Photographs or video clips (so that a new cohort may more easily find you by looking at the photograph or digital image in an alert)
Current location (may be in the form of a city and state or more precise information such as one's current GPS location)
Date of birth and/or current age
Employment history
Educational history
Residential history
Any other data elements that one may wish to include in an embodiment so that it can be available in cohort alerts and/or to users in their establishing search/filtering criteria

The identity and profile management service 104 may also provide the ability for users to select or identify cohort groups with which they belong or want to be associated. These cohort groups may be searched for and selected from an existing inventory of cohort groups or, users can create a new cohort group. When creating a new cohort group, the entity typically will define particulars for the cohort group. As a non-limiting example, a new cohort group may be defined by including the following information:
(a) a name for the cohort group, usually a descriptive name would be preferred (e.g., MIT alumni from the '80s, Woodstock Attendees, Ironman Athletes);
(b) a textual definition/explanation regarding the cohort group;
(c) one or more categories with optional sub-categories into which this cohort group falls or belongs (e.g. an organization and within that category this is a religious organization)

The event detection processor 108 operates to detect the occurrence of events that may be used to trigger cohort actions (e.g. cohort alerts, linking of cohort groups, cohort group broadcast, updating profile information, etc.) and then respond to those cohort events. A wide variety of events can be incorporated and/or processed by various embodiments of the present invention and for purposes of illustration, a few non-limiting examples of such events are summarized.

Location based events. With the integration of location tracking systems, such as GPS, into handheld communication devices, such as cellular telephones, laptops, etc., the location of cohorts may be available for processing and use by the various components of a system. In an exemplary embodiment, the location of cohorts, or the proximity of cohorts to each other, objects, events or the like can be used to trigger alerts. For example, whenever a cohort is within a certain range from another cohort, or within a threshold distance, this may be considered a triggering event. The range could be very tight, such as within 10-20 feet, or it may be broader such as a number of miles, or within the same city, building or event. Of course, for location information, the embodiment of this invention may not rely on technology at all. In some cases it may rely solely on the entity self-identifying its location across the system (e.g. specifying a current city and state or a schedule for the next period of time with locations to be visited and expected arrivals and departures.)

Profile creation/content related events. Any of the information that is entered or created within a cohort's profile may potentially be used to drive alerts. For example, when a cohort (i.e. an entity that self-identifies with a cohort group or a selected cohort group) updates his/her/its profile by changing the location, city/state of residence, age, adds other demographic information such as schools attended, or any other traits, etc., this activity can be detected by the event detection processor 108 and identified as an event. Thus, events can occur as the result of creating a profile, modifying a profile, deleting information from a profile or simply deleting or otherwise deactivating a profile.

Referral related events. In some instances, one entity my be aware of and desire to refer one cohort to another user for any of a variety of reasons. However, such a referral will generally occur when the entity knows that the cohort being referred also identifies with a cohort group of the party being referred to, or has some other commonality with the other party. When a user refers a cohort to another entity, this can be identified as an event and the event may have access to all information about known cohort relationships.

Transitive discovery events. It is conceivable that two parties may create similar cohort groups or, that there may be a reason for two or more cohort groups to join together. For instance, if two parties that attended the same school at the same time started a class alumni cohort group, once discovered, processor 108 may automatically and/or at the request/approval of the group starter, connect the groups. When two or more cohort groups are linked together, the event detection processor 108 may monitor activity in each separate group. Upon detecting activity, such as a new cohort joining one group, the event detection processor 108 may identify this as an event to be alerted.

Similarly, the other events mentioned within this disclosure, as well as events not listed may also result in transitive discovery events. For example, such events may include a referral to a cohort in one of the linked cohort groups, modification of a profile of a user in one of the linked cohort groups, location based events, etc.

Searching related events. The identity and profile management service 104 may include a search engine and an interface, such as a user interface or process interface, for exercising the search engine. When a user performs any of a variety of searches through the identity and profile management service 104, the results may invoke or cause an event. For instance, a user may conduct a search to identify or find new cohorts within a particular cohort group. If the search obtains positive results, the user may then generate alert events to the newly found cohorts. Alternatively, the system may automatically generate alerts subject to the alert allowances of the various user profiles. Similarly, a user may conduct a general search looking for cohorts that satisfy particular search criteria but that are not, or may not necessarily be in a cohort group.

Those skilled in the art will appreciate that a variety of searching techniques may be used in this aspect of the invention.

API related events. The service platform 100 (and through that platform each of the components within it: i.e., the identity and profile management service 104, event and detection processor 108, etc.) in any embodiment may include an interface, or application program interface, to external systems and or processes. Through this interface, external systems or processes 160 may cause or invoke events to occur, or the event detection processor 108 may provide triggers for events in external systems. Furthermore, the external systems and/or processes may, in addition to driving and/or receiving events, also provide value-added services. As a non-limiting example, an email client could perform a search on an intended email recipient and include all coincident cohort groups identified between the sender and the receiver in the email. This would add value to the email by augmenting it with the known commonalities between the sender and the receiver. This, of course, could further allow these enhanced email systems to recognize this message as “non-spam” and/or more important than other email traffic based, at least in part, on the commonality and importance of the coincident cohort groups. Thus, the email messages that are so processed, may be tagged or identified as special emails and thus, bypassing spam filters or other filters. In addition, other actions can be taken with regards to the email, such as linking cohort groups. As such, an external email system, upon reception of an email and identifying cohort groups that are common or related to the addressee's may interact with the event and detection processor 108 to indicate the occurrence of an event—namely identifying parties that should be related in cohort groups.

Broadcast related events. The event detection processor 108 may include or employ the use of one or more cohort group alert “listeners”. A cohort group listener receives alerts based on a variety of criteria. For instance, all of the alerts from cohorts in a cohort group that have selected to broadcast to: (a) a specific listener, (b) all listeners associated with a cohort group or (c) a subset of listeners on a cohort group limited by some search criteria, will then be received by the appropriate listeners. With regards to the subset of listeners, the subset can be selected based on a variety of search criteria, such as listeners created within the last month. An example of where this functionality can be utilized is within a professional organization's cohort group that may wish to publish the advertisements of its cohort members to a public website or perhaps to a large-screen display at a major conference.

The alert service 112 operates to generate and transmit cohort alerts, typically in response to a cohort event recognized by the event and detection processor 108. The alert service 112 performs the alert preparation and transmission/retransmission steps necessary to ensure delivery of an alert. For instance, the alert service 112 may receive a message or signal from the event and detection processor 108. The message may include the identity of one or more recipients for the alert. It should also be understood that the message from the event and detection processor 108 may not include the identity of a cohort but rather a class of cohorts, one or more cohort groups, or search criteria or wildcards used to identify recipients. The alert service 112 may interface with the profile database 116 and/or the system configuration database 120 to gain further information in formulating alerts. As a non-limiting example of how an embodiment of the alert service may work, an exemplary alert service 112 may include one or more of the following operations:
(a) receiving an event message from the event and detection processor 108;
(b) parsing the message to determine what, if any alerts should be sent in response to the message;
(c) parsing the message to identify cohorts to receive the alerts;
(d) retrieving the profile of intended cohorts;
(e) inspecting the alert preferences in the cohort's profile to determine how to format the alert (i.e., should/can the alert include a picture? What text should be included? Is there a size/character limit?)
(f) preparing the alert using content from the message, content from the profile, respectful of the alert preferences expressed in the profile, and also respectful of any constraints that may be introduced because of the transmission mechanism that will be used (e.g. SMS cannot transmit video even if it is available and the preferences would allow its inclusion.)
(g) transmitting the alert using the appropriate mechanism(s) or transceiver system 124 specified in the recipient's profile and, when possible, listening for confirmation that the alert was received. If confirmation is possible/available and it is not received within a configurable timeout period, the alert service 112 may retry a configurable number of times to resend the alert. If the configurable number of retries has been attempted and confirmation is still not received, the alert service 112 may attempt to try any alternative delivery mechanisms.

The transceiver system 124 may include a variety of transceiver and/or transmitter technologies and the present invention is not limited to any particular technology or set of technologies. For instance, the transceiver system may include any of the following technologies, as well as other technologies: Bluetooth wireless, pager, flex pager, cellular CDPD, TDMA, CDMA, 3G Wireless, WiFi (802.11a/b/g), text messaging, SMS, FTP, SMTP, IMAP, email, web postings, etc.

The client service 128 enables a user to perform all or a subset of cohort activities, such as receiving cohort alerts, managing his or her profile, performing cohort searches, linking cohort groups, etc. In one embodiment, the client service 128 may be a system that can be deployed to user devices, such as but not limited to, cellular telephones, Personal Digital Assistants (PDAs), laptop computers, desktop and server computers, etc. that can provide a user with access or an interface to the service platform 100. Additionally, the various embodiments of the client service 128 can leverage any currently or in the future available client devices to receive alerts, and/or transmit profile updates and/or provide any other available cohort functionality. Some currently available examples include:
Using a standard web browser from an Internet-capable device. This provides a simplistic and easy to understand method of interaction with the identity and profile management service 104 and a common way to access alerts, a copy of which are typically linked to the cohort's profile.
Using a telephone.
Using written correspondence scanned in or converted by ocular technology.
Using any email client.
Using any Short Message Service (SMS) client.
Using any Multimedia Messaging Service (MMS) client.
Using any Bluetooth enabled device to receive alerts via Bluetooth file transfer or any other application capable of connecting over Bluetooth.
Using an Intranet network or application.

Embodiments of the invention that deploy a more full-featured client service 128 may be deployed on a cohort's device 150A, 105B, 150n and may include components that in part, replicate or replace the typically server-based services for identity and profile management service 104, the event and detection processor 108, and alerts service 112. This can allow for two cohorts to have peer-to-peer interactions and cohort operations even when a central server with more scalable implementations of these services is not reachable.

A better understanding of various aspects, features and operations of various embodiments of the present invention may be realized by examining exemplary applications of embodiments of the invention. It should be understood and appreciated that the various embodiments, and aspects and features of such embodiments, may be deployed or utilized in a wide number of applications and across a wide array of aspects of people's lives. However, a few illustrative, and non-limiting examples are provided. Note, in many applications of this invention, there are at least two possible architectures—both of which can be present at the same time—which may be working to provide the application in one or both styles. These two styles include:
1. Peer-to-peer: The client service 158 described above on one cohort's device (cellular telephone, PDA, laptop, etc.) can send an alert directly to the client service 158 on the other cohort's device.
2. Server-based: The typical server-based components of embodiments of this invention (the identity and profile management service 104, event and detection processor 108, and alert service 112) which are scalable up to support as many cohorts as come online around the globe, handles the majority of cohort operations and processing across clients.

One example of an application of the present invention includes live cohort encounters. In this application, the embodiment of the present invention can leverage real-time aspects to find cohorts in the immediate vicinity. For example, as a user is walking around a specific location, such as in attendance of an event, shopping in a mall or other area, dining, etc., embodiments of the invention can be applied in identifying cohorts in a user's vicinity and then alerting the user to the same. Such an embodiment of the present invention would utilize a location-awareness technology for cohorts down to a fair degree of accuracy. Such information can be obtained from a variety of sources such as by using GPS receivers in cellular telephones or PDAs, position triangulation algorithms based on WiFi or other beaconing devices (such as is used for positioning in the APPLE IPHONE), entity self-identification of position to the system, or any other positioning means.

Another example of an application of the present invention is referred to as cohort solicitation. In this application, the embodiment of the present invention can leverage cohort group awareness to find people with a common interest, and optionally within a particular context. Examples could include finding like-minded people in a new town that a user has moved to or has traveled to, and who enjoy a hobby or other interest in common with the user. In these situations, the user will want to leverage real-time or near real-time cohort requests to attract like-minded people. Typically a cohort search is run and then alerts are initiated to those cohorts in the search result set.

Alternatively, this feature could be performed by leveraging the listener approach to broadcast your cohort alert through relevant channels fed by the listener. These applications are obviously not mutually exclusive, as it should be evident that one could perform cohort solicitation at an event by leveraging both live cohort encounter mechanisms simultaneously or together.

Another example of an application for the present invention is referred to as cohort sharing. In general, this application may operate to share newly discovered cohorts with others that are in the same or similar cohort groups. In a typical embodiment, this can be accomplished by dynamically linking cohort groups. However, the techniques of broadcasting through listeners and/or sending cohort alerts as the end result of search activities can also be used to share cohorts.

There are a variety of other embodiments of the present invention that may also be appreciated by those skilled in the art. In addition, the various embodiments of the invention may include any number of a variety of extensions and modifications that may also be considered as novel aspects of the various embodiments of the invention. For instance, in one embodiment, the invention may be deployed without any server software components. Such an embodiment results in a pure peer-to-peer operation of this invention where each individual's profile is stored and managed locally on his/her device and all alerts, broadcasts, and other messages flow directly between the client devices.

Another embodiment of the present invention may be deployed without any sophisticated client software components. This embodiment results in a pure server-based system. In such an embodiment, all information and processing is performed on the server-based systems either accessed directly or through simplistic client devices (e.g., a thin client)

Embodiments of the present invention may also leverage new, specialized, or simply different communication and/or application mechanisms to perform profile and cohort event detection and processing activities. For instance, optical networking on one end, and then physical letters or telegrams, or in-person delivery, mechanisms on the other end.

Still some other embodiments may include tools or techniques for managing cohort categories not just manually but also in a semi-automated or fully automated fashion. As life is busy and many individuals operate at full throttle, it can be difficult to take the extra time to police one's cohort groups or contact lists to eliminate redundancy, errors or sloppiness. Such tools and techniques manage cohort categories and groups to ensure that there are not any, or a limited amount of, replication and/or ambiguity. This can be critical as entities can add their own groups and categories over time. For instance, this tool can periodically scan a user's cohort groups and conduct an exhaustive search of cohort groups in which each of the members belong. The system can flag suspected irregularities on a user's cohort groups. For instance, the system may scan all the cohort groups of a user's business contacts for irregularities. If the system identifies a contact is also a member of a cohort group of students graduating from a particular high school in 2008, the system may raise this as a suspicious grouping. The user can then be notified of the suspicious relationship and given the opportunity to accept, cure or delete the cohort from the user's cohort group. This implies another possible feature of these embodiments, that being a semantic processor that can apply notions of meaning to cohort groups or other elements within the system, e.g. the age implied by a graduation date.

Embodiments may also allow the system profiles, cohort group categories, cohort groups, cohort associations, etc. to be monitored/arbitrated/supervised by one or more human administrators or automated processes. For example, such features and capabilities employed may include looking for illegal or otherwise objectionable or offending content or use.

In view of the above two embodiments, embodiments of the present invention may also employ the use of tools and techniques to rate, recommend, or otherwise qualify cohort profiles and/or alerts. For instance, black lists and white lists can be maintained as well as mechanisms for users to report unwelcomed activities of other parties.

Other embodiments may employ the use of non-repudiation mechanisms for cohort alerts. The use of automated filters and human filtering are limited in many aspects. Thus, there may be a great desire and benefit in using mechanisms to prevent unwelcomed alerts from being fully received and also, to ensure that alerts come from valid and trustworthy sources. The use of signatures, public keys and personal verification information can be used to ensure that alerts are valid and/or trusted.

Embodiments of the present invention may provide analytical tools to help identify statistical information about cohort groups. The cohort service tools may allow users to see the number of cohort groups, the average number of cohorts in the groups, the average age of cohort group members, or statistics based on other demographics such as race, profession, education, interest, place of residence, etc, or more sophisticated analytic results over the information across the cohort system by examining data on the servers and or clients. This aspect of the various embodiments may be very beneficial in determining if a user wants to be associated with a cohort group or not. This information may also enable a user to determine why results from one cohort group vary from that of another cohort group. Further, such information may also be useful in determining if a particular party or entity wants to target a cohort group with solicitations, recruitments or advertisements, etc. The inclusion of such cohort-aware or cohort-based advertising, recruitment, or other solicitation mechanisms represents other potential variations for embodiments of this invention.

Embodiments of the invention may also provide validation mechanisms for profiles and/or identities. For instance, in one embodiment, this feature may include authenticating and validating a person who is associated with a profile. Further, this aspect of the invention may operate to verify not only that the person creating a profile is legitimate (by any set of criteria that an embodiment or its users may establish for legitimacy), but also that the information being provided is legitimate, such as ensuring the person's name, age, photo, education, etc. are indeed representative of this person. This feature can be implemented in a variety of ways, including requesting references or searching other trusted information sources such as credit reports, employment records, school records, etc. Furthermore, criminal checks and background checks may also be performed on the parties.

The various embodiments may be augmented or restricted by adding or limiting the various types of media and/or interaction capabilities. For instance, one embodiment may allow users to place streaming video into the profiles or alerts. As another example, interactive elements such as “chat boxes” can be included in user profiles, cohort groups, or alerts and messages.

Another feature that can be included in various embodiments of the present invention is controlling mechanisms for the delivery of alerts. For instance, alerts can be batched together for delivery or scheduled for delayed delivery. Such features may greatly benefit the efficient use of bandwidth for alerts that are not time-sensitive.

In some embodiments, when an alert is received a new cohort may automatically be added into a user's cohort group. However, in other embodiments, mechanisms may be provided so that cohorts can accept, reject, archive, suspend, report, etc. cohort alerts. For instance, a cohort alert could be archived and investigated by a user for later acceptance or rejection. Further, a continued and persistent cohort alert that is a nuisance, such as spam emails are today, may be reported or rejected either manually or automatically by setting up automated processing logic or rules.

Advantageously, aspects of the present invention may also be integrated into other systems and/or broader networks, applications, or systems. For example, aspects of the present invention may be included or incorporated into an email system, CRM, ERP, SCM, or other system. In such embodiments, the present invention may operate along with contact lists, customer lists etc., to create and manage cohort groupings to facilitate analysis or communication. In this case, the cohort groups of this invention and the functionality around cohort groups that this invention provides can operate seamlessly with the native information and functionality of the other system(s). This allows them to share information and functionality back and forth, or bi-directionally, to enable notions such as “cohort groups of business to business (B2B) customers” that are related by business styles or executive interests and “cohort groups of contacts” within the address book that can be clustered and re-clustered in many, many useful ways along diverse cohort-relationships.

Embodiments of the present invention may also provide tools and features to give cohort entities capabilities to process sets of profiles and/or alerts in more sophisticated ways. For instance, users may be able to apply a variety of functions such as sorting, filtering, automatically responding in a variety of ways such as deleting or replying, etc. to alerts and profile searches.

Other embodiments of the present invention may allow users to select other operational characteristics of the system, such as the language used, currencies supported, and enabling the ability to have a multi-cultural, global environment potentially with automated or human translations of content. For instance, an embodiment may allow cohort groupings to be formed across countries, and alerts being sent to various users may be automatically translated into the native language for the recipients.

In contrast, embodiments of the present invention may be limited to a restricted environment or scope. For instance, the embodiment may be deployed only within a particular company or organization. Similarly, the embodiment may be deployed with only portions of the functionality, such as elimination of the listeners and broadcast elements. In addition, embodiments may limit the communication mechanisms based on any variety of factors.

Embodiments of the present invention may employ various types of artificial intelligence, fuzzy logic, scripting, decision-support, heuristics or other more advanced types of automation in the system to allow cohort events and activities to be automatically or semi-automatically generated, filtered, responded to, or otherwise processed.

Embodiments of the invention may also support branded or otherwise “proprietary” cohort groups that may have an external “owner” who has rights to that branded or otherwise proprietary group. Such embodiments may include and support the use of special administrative powers within the system on that group or groups for the allowing or blocking of content or users, special controls over linking, or other powers over system activities.

Embodiments of the present invention may also include mechanisms to manage “overload” across the system which can occur at a variety of points. For instance, mechanism can be implemented to prevent or otherwise handle in more graceful ways any of the following events or occurrences:
a. Too many alerts being presented to a particular user
b. Too many cohort groups being created
c. Too many cohort groups being created for a particular category
d. Too many categories being created for cohort groups
e. Too many communication channels to manage or try when sending alerts out to cohorts.

The various embodiments may limit activity to prevent or otherwise manage such occurrences.

Embodiments of the invention may also support the use of proxies within the system so that a user may allow another party to perform cohort operations through his or her identity and/or profile on his or her behalf. This can be done with or without transparency. For instance, in one embodiment this can be done without visibility into the fact that a particular proxy user instead of the actual user was performing these actions.

Embodiments of the invention may also support what may be termed “Machine-to-Machine” (M2M) interactions between cohort entities where no human user is involved in the regular transactions. As an example of this, two or more governments could leverage this invention by maintaining trusted cohort groups of their official employees, with each cohort group implying various levels of credentials/access/expertise (e.g. State Department; expert in China; authority to negotiate trade relations for agricultural products) and automatically exchange, verify this information in real-time using an automated process at each endpoint (e.g. in each country participating).

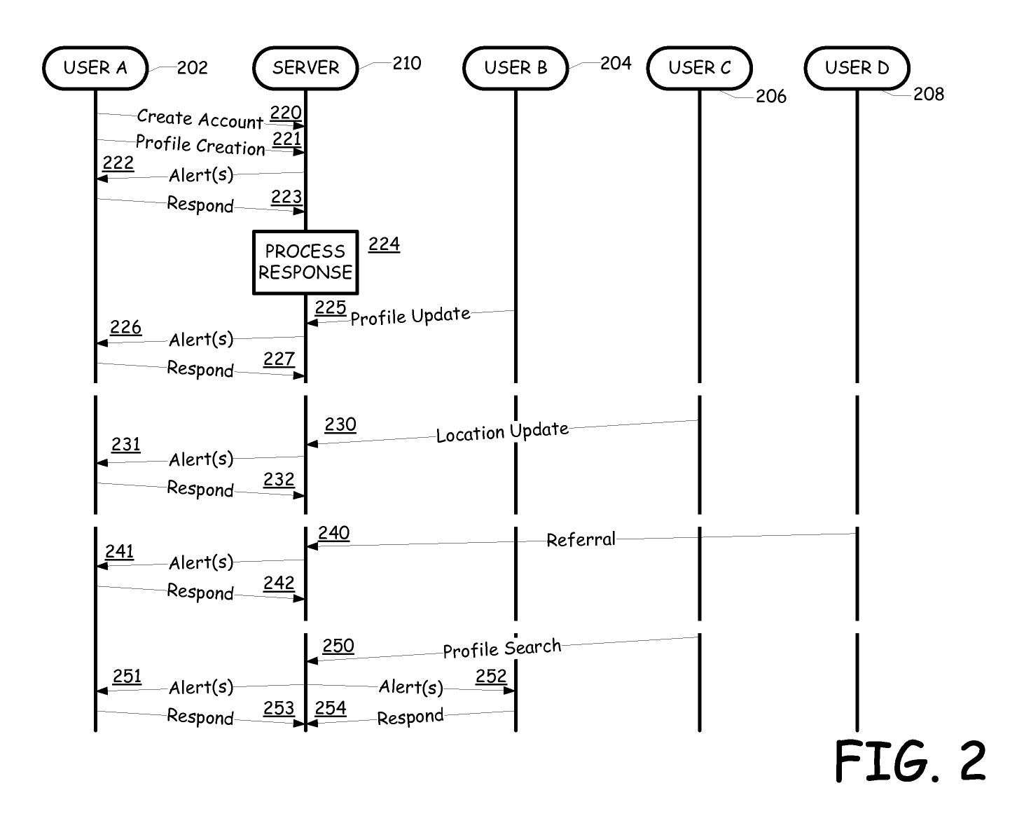

FIG. 2 is a communication flow diagram illustrating the operation of various components and communication steps in an exemplary embodiment of the present invention. The diagram illustrates the existence of four users, user A 202, user B 204, user C 206 and user D 208 with a server system 210 operating in a server-oriented embodiment of the invention. Each of the users may be operating a stand-alone mobile device with a client server, or may be directly logged into the server system using a thin client, as well as other configurations.

The communication flow steps of 220-227 illustrate the general operation of an embodiment of the invention for triggering and responding to an alert based on a profile update of a user. Initially, user A 202 interacts with the server 210 to create an account 220 and then provide or create a profile 221 that defines required and/or optional information about the user. User A may be prompted for the profile data based on definitions in the system configuration database 120 and the profile data is then stored in the profile database 116. The profile data may be used to generate alerts, or it may be used to determine if user A 202 should receive alerts. In the illustrated embodiment, after the profile is entered into the server 210, the server 210 conducts an analysis and then generates one or more alerts 222 to be sent to user A 202. User A 202 can respond to the alerts in a variety of manners including accepting, rejecting, suspending, considering, reporting, etc. the alerts. The response 223 of user A 202 is then sent back to the server 210 where the response is processed 224. For instance, if user A 202 accepts an alert requesting the user to be included into a cohort group, the server system 210 may then include user A 202 in the cohort group, notify other cohorts in the group of the addition of a new cohort, look for similar cohort groups that user A 202 may be interested in, identify cohorts in the group that are in close proximity to user A 202, etc.

In the illustrated embodiment, user B 204 is subsequently shown as updating his or her profile 225. This is communicated to the server 210 which may determine that the modifications warrant an alert 226 to be sent to user A 202. The alert may be a positive or a negative alert. For instance, if user B 204 modifies his or her profile so that a commonality exists between user A 202 and user B 204, then a positive alert may be sent to user A 202, as well as user B 204 (not shown) to indicate that the two parties may belong in a cohort grouping. In the alternative, the modification to the profile may remove a commonality between user A 202 and user B 204 in such a manner to trigger a negative alert indicating that a current cohort group that includes both parties should be modified to exclude one or more of the parties or, be disbanded altogether. Similar to the first alert, user A 202 responds to the alert 227 which is then processed by the server 210.

In the illustrated embodiment, steps 230-232 illustrate exemplary steps involved in a location based trigger or alert. In the illustrated embodiment, some event occurs relative to user C 206 that causes user C 206 to provide a location update 230 to the server 210. The location update could be the result of a request from the server 210, another user on the system, a periodic event that automatically occurs, the detection of movement beyond a threshold amount, manual prompting, or a variety of other activities. The location update 230 is received by the server 210 and processed. The server 210 is shown as determining that the location update 230 of user C 206 invokes an alert 231 to user A 202. As an example, this alert may simply be an indication to user A 202 that a cohort user C 206 that shares one or more cohort groups in common with user A 202 is within a certain physical distance from user A 202. Alternatively, the two users may not belong to a common cohort group but, now that they are within a given proximity to each other, the server 210 determines that they should belong to a temporary cohort group so that they can be connected. For instance, in a particular example, the profile for user A 202 may indicate that user A 202 is interested in purchasing vintage boats. Although user A 202 is not a member of a cohort group with user C 206, the profile for user C 206 also indicates that he has an interest in vintage boats. Now that the two parties are in close proximity, the server 210 may alert both parties, or in the illustrated embodiment one party, to put them on notice of a potential beneficial cohort relationship. If user A 202 responds in a positive manner, an alert may be sent to user C 206 to further the contact. As another example, the alert 231 may indicate to user A 202 that user C 206 has moved outside of a threshold range or distance from user A 202. As yet another example, the location triggers may simply be used to help benefit from others based on location. For instance, suppose user A 202 and user C 206 both are in a cohort group, such as the same family or company. The profile for user A 202, or descriptive matter for the cohort group may indicate that the cohort group needs a certain supply (i.e., milk) or has other needs. If the location update 230 from user C 206 indicates that he or she is in the vicinity of a grocery store or other location which could benefit another cohort or the cohort group, the alert 231 to user A 202 may simply indicate that another alert will be sent to user C 206 in an effort to benefit from the location of user C 206 (i.e., request user C 206 pick up the supplies) and so, user A 202 does not need to make a trip to do the same.

In the illustrated embodiment, flow steps 240-242 illustrate processing of a referral request. In the illustration, user D 208 is shown as sending a referral to the server 210. A referral can take on a variety of formats, such as (a) identifying attributes of another cohort that a first user has found beneficial and wants to put the world or some public segment on notice, (b) identifying a particular party that another particular party may benefit from, (c) identifying a particular party that a cohort group may benefit from, (d) identifying a particular cohort group that one or more user's may benefit from, etc. In the illustration, the referral 240 is received by server 210. Server 210 then processes the referral to determine where, if any, alerts should be sent. The processing may simply include extracting specific cohorts or cohort groups from the referral, or it may require more sophisticated processing such as analyzing the profile of a referred cohort or cohort group and identifying other cohorts that should be alerted, or examining other information in the referral and cross-correlating that information with profiles of other cohorts or cohort groups. In the illustration, it is shown that the server 210 identifies that at least user A 202 should receive an alert 241 regarding the referral, to which user A 202 provides a response 242.

The illustrated embodiment also shows exemplary steps involved in a profile search based alert. User C 206 is shown as conducting a profile search. This profile search may take on a variety of characteristics, including a word search, an educational affiliation search, a colleague search, a classmate search, a general topic of interest search, a geographic location search, an expertise search, a knowledge base search, etc. Regardless of the particular searching criteria and capabilities, the profile search results 250 are obtained by the server 210. The server 210 may then automatically or subject to approval by user C 206 identify other parties that should be alerted as a result of the search and then send out the necessary alerts. For instance, in the illustrated embodiment, the server 210 determines that the search results identified two parties, user A 202 and user B 204 that should receive an alert and the alerts 251 and 252 are sent to them respectively. As an example, the alert may indicate that user C 206 has conducted a search for electrical engineers with 5 years of experience in transmitter and antenna impedance matching and that the receiving user is identified as matching the criteria. The users may then respond to the alert 253 and 254 respectively and the server may process and take appropriate actions.

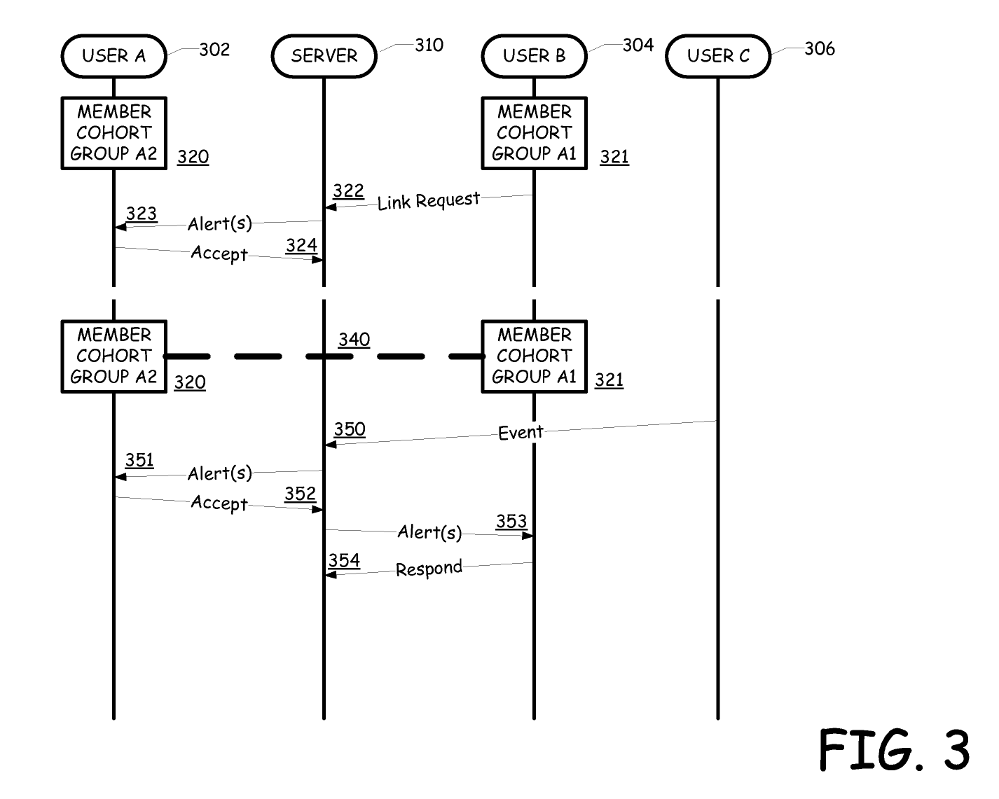

FIG. 3 is a communication flow diagram illustrating additional operations of various components and exemplary steps in an exemplary embodiment of the present invention. The diagram shows the existence of three users, user A 302, user B 304 and user C 306 with a server system 310 operating in a server-oriented embodiment of the invention. Each of the users may be using a stand alone mobile device with a client server, or may be directly logged into the server system using a thin client.

Process flow steps 320 to 324 illustrate operations involved in an exemplary embodiment of the invention in linking up two, currently unlinked cohort groups A2 320 and A1 321. Initially, user B 304, who is a member of cohort group A1 321, sends a link request 322 to the server 210. The link request 322 may take on a variety of forms, such as specifically identifying a cohort group with which user B 304 wants to link cohort group A1. Alternatively, it may identify general characteristics, features, aspects or descriptions of what cohort group A1 is all about, and what they are seeking. It should also be understood that in various embodiments of the invention, the server 310 may automatically invoke linking requests based on the knowledge of various cohort groups and various reasons as to why they should consider being linked. For instance, if there is a considerable overlap of common members between two groups, the server 310 may automatically send out alerts to request linking the groups. As another example, the server may identify common descriptive subject matter in two cohort groups and conclude that linking the groups should be considered. As yet another example, artificial intelligence may be applied by the server to identify two, at first look unrelated, groups that could potentially benefit from each other. For instance, in an EBAY like environment, the server 310 may identify parties that are looking for a particular product with parties that are trying to sell similar or related products. In the illustrated embodiment, the server 310 receives the link request 322 and notifies user A 302 via an alert 323, that a member, for instance an administrator, of cohort group A1 321 is requesting consideration of a link between cohort group A1 321 and cohort group A2 320. If user A 302 responds in a positive manner, as is shown with the accept message 324, the link can be created as further shown in FIG. 3 as link 340.

Process flows 350-354 of FIG. 3 illustrate the general operation of an event occurring that triggers alerts to multiple groups that are linked. In the illustrated embodiment, an event 350 occurs. The event can be any of a variety of events as previously described, as well as other events. The server 310 processes the event 350 and determines which alerts, if any, should be transmitted. In the illustrated embodiment, the event 350 invokes an alert that should be sent to one or more members of cohort group A2 320. The alert 351 is sent and then accepted at 352. In response to the acceptance, the server 310 then determines that one or more members in the linked cohort group A1 321 should also then be alerted. This alert 353 is then sent and the one or more members of cohort group A1 321 may transmit a response 354 to the server 310. In the illustrated embodiment, the multi-alert to linked groups is shown as being hierarchical in that only after one or more members in cohort group A2 320 accept the alert are members in cohort group A1 321 notified. It should be appreciated that in other embodiments, parallel alerts may be sent to both groups as well as to multiple members in multiple groups.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art as will new cohort profile, cohort event, cohort event detection, and other cohort processing features.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb. Further, the term user does not necessarily mean a person is required, and it could be interchanged with a process, system or entity.

It will be appreciated by persons skilled in the art that the present invention is not limited by what has been particularly shown and described herein above. Rather the scope of the invention is defined by the claims that follow.

What is claimed is:

1. A method for dynamically generating and updating associations based on characteristics and providing alert messages to one or more entities with regards to association affiliations, the method comprising the steps of:
receiving entity pertinent information from a plurality of entities and storing the entity pertinent information into a profile database;
identifying a first characteristic that exists in the pertinent information of two or more entities;
creating a first association based on the first characteristic;
sending an alert message to at least one of the two or more entities indicating a potential affiliation with the first association; and.
affiliating the at least one entity with the first association.

2. The method of claim 1, wherein the step of identifying a first characteristic further comprises identifying a trait in the entity pertinent information that is common to at least two or more entities.

3. The method of claim 1, wherein the step of identifying a first characteristic further comprises the steps of:
parsing the entity pertinent information to identify traits; and
identifying one or more traits that are common to at least two or more entities as the first characteristic.

4. The method of claim 1, further comprising the steps of:
receiving a self affiliation request from a requesting entity, the request identifying a particular association;
affiliating the requesting entity with the association.

5. The method of claim 1, wherein the step of sending an alert message further comprises sending a request to at least one entity indicating a potential affiliation with the first association and requesting the at least one entity to confirm the affiliation and, further comprising the step of receiving an affiliation confirmation from the at least one entity.

6. The method of claim 1, wherein the step of sending an alert message further comprises the steps of:
identifying any rules associated with sending alert messages to a particular entity; and
sending the alert message subject to the identified rules.

7. The method of claim 6, wherein the rules are included in the entity pertinent information provided by an entity.

8. The method of claim 1, wherein the step of sending an alert message further comprises sending a request to each of the two or more entities indicating the potential affiliation and requesting each of the two or more entities to confirm the affiliation.

9. The method of claim 1, further comprising the steps of:
detecting an event;
determining if the event has an effect on the affiliation of the two or more entities with the first association; and
sending an alert message to each entity effected by the event.

10. The method of claim 9, wherein the step of detecting an event comprises receiving location information for one or more of the affiliated entities.

11. The method of claim 9, wherein the step of detecting an event comprises receiving location information for one or more affiliated entities and determining that at least two affiliated entities are within a threshold geographic range from each other and, the alert message conveys this information.

12. The method of claim 9, wherein the step of detecting an event comprises receiving location information for one or more entities and determining that at least two of such entities are within a threshold geographic range, and the step of sending an alert message further comprises sending a message indicating that the two or more entities are affiliated with an association based at least upon their respective locations.

13. The method of claim 9, wherein the step of detecting an event comprises receiving location information for one or more entities affiliated with the first association, determining that the location of the one or more entities can benefit another of the affiliated entities and, sending an alert message related to attaining this benefit.

14. The method of claim 9, wherein the step of detecting an event comprises receiving updated entity pertinent information for one or more entities.

15. The method of claim 9, wherein the step of detecting an event comprises receiving a referral from a first entity that is directed towards a second entity and suggesting an affiliation with regards to a third entity.

16. The method of claim 9, wherein the step of detecting an event comprises receiving a link request identifying a second association and a desire to link it with the first association.

17. The method of claim 16, further comprising the step of sending an alert to one or more entities affiliated with the first association requesting approval of the link with the second association.

18. The method of claim 9, wherein the first association is linked with a second association that includes one or more affiliated entities, and wherein the step of sending an alert message to each entity effected by the event further comprises sending the alert message to entities affiliated with the first association and entities affiliated with the second association.

19. A system for dynamically generating and updating associations based on characteristics and providing alert messages to one or more entities affiliated with an association, the system comprising:
an identity and profile management service that receives entity pertinent information from a plurality of entities and stores the entity pertinent information into a profile database, searches the profile database to identify one or more characteristics that exist in the pertinent information of two or more entities, creates one or more associations based on the identified characteristics, and affiliates two or more entities with an association based at least in part on the existence of the characteristics in the pertinent information;
a processor that interfaces with the identify and profile management service to determine when two or more entities are affiliated with an association, and to determine when two or more entities are within a threshold distance from each other, and in response to either situation, generate events;
an alert service that interfaces to the processor and sends an alert message to entities upon determining that an event was generated for that entity; and
a client service for each of the plurality of entities, the client services interfacing to the alert service for receiving alerts, to the identify and profile service for providing updated entity pertinent information including a current location for the client service.

20. A method for dynamically generating and updating associations based on characteristics and providing alert messages to one or more entities with regards to association affiliations, the method comprising the steps of:
receiving entity pertinent information from a plurality of entities and storing the entity pertinent information into a profile database;
parsing the entity pertinent information to identify traits;
identifying traits that are common to at least two or more entities;
creating associations based on the common traits;
sending first alert messages to two or more entities sharing common traits with the associations;
affiliating the entities with the associations upon receiving a response to the alert messages;
receiving location information for one or more entities and determining that at least two affiliated entities are within a threshold geographic range;
examining alert rules associated with the at least two affiliated entities that are within the threshold geographic range; and
sending second alert messages, subject to the alert rules, to the affiliated entities that are within the threshold geographic range, the alert messages indicating that the receiving entity is within a threshold geographic range of another entity.
